(19) United States
(12) Patent Application Publication
(10) Pub. No.: US 2004/0158836 A1
(43) Pub. Date: Aug. 12, 2004

(54) GSM-SCA unified object model

(76) Inventors: Ronald P. Adkins, Melbourne, FL (US); Thomas L. Jordan, Melbourne, FL (US)

Correspondence Address: SACCO & ASSOCIATES, PA, P.O. BOX 30999, PALM BEACH GARDENS, FL, 33420-0999, US

(21) Appl. No.: 10/364,724

(22) Filed: Feb. 11, 2003

(51) Int. Cl. G06F 15/163

(52) U.S. Cl. 719/310

(57) ABSTRACT

A unified object model, which is a rational, summative definition of multiple object model specifications. The unified object model can support administration of a network element by a plurality management applications communicating via different network protocols. For example, the unified object model can support administration by Global System for Mobile Communication (GSM) management applications, Software Communications Architecture (SCA) management applications, simple network management protocol (SNMP) management applications, or any combination of these. A plurality of application programming interfaces (API's) are provided for communication between the plurality of managed objects in the MIB and the plurality of software applications for performing data accessing and mutation to support interoperability. The plurality of API's can include all methods associated with a respective object model.

### BACKGROUND OF THE INVENTION

1. Statement of the Technical Field

The inventive arrangements relate generally to the field of mobile communications, and more particularly to mobile communication system object models.

2. Description of the Related Art

There are currently a number of different mobile communication systems, each operating with different protocols. Global System for Mobile Communication (GSM) is a digital mobile communication system m that is widely used in Europe and other parts of the world. GSM uses a variation of time division multiple access (TDMA) and is the most widely used digital wireless telephone technology. In each GSM base station system (BSS), an operations and maintenance center-radio (OMC-R) is provided to provide operations, administration and maintenance for the BSS, including the functionality that enables an operator to monitor and manage the system.

To effectively administer the BSS resources through operations, administration and maintenance, the GSM standards specify a management information model (object model) which defines the inheritance, containment, and entity relationships of the BSS resources. The GSM object model is defined in ETSI 12.20, “Digital cellular telecommunications system (Phase 2); Base Station System (BSS) Management Information” and includes objects which, collectively, define the BSS resources. The objects are formally described using the description techniques from industry standards: CCITT X.722, Guidelines for Definition of Managed Objects; and X.208, Specification of Abstract Syntax Notation One (ASN.1).

The GSM object model was drafted to include a definition for a GSM management information base (MIB) which provides operability with telecommunications network managers or Simple Network Management Protocol (SNMP) managers. The GSM object model contains the complete description of all BSS resources needed by the GSM administration and maintenance system to administer the network. Additionally, the GSM object model defines the BSS network resource attributes that are specific to GSM; for instance, handover and power control and frequency hopping. Although the GSM object model is completely defined for GSM, and is extensible, to a degree, to permit customization by individual GSM BSS suppliers, GSM still is a narrowly tailored specification. Software Communications Architecture (SCA), on the other hand, has been defined to be more versatile.

SCA has been generated to support the U.S. Government's Joint Tactical Radio System Joint Program Office's mandate to pursue the development of future communication systems, capturing the benefits of the technology advances of recent years. In order to achieve the Joint Program Office's goals, SCA is defined to provide for portability of application software, leverage commercial standards to reduce development cost, reduce development time of new waveforms through the ability to reuse design modules, and build on evolving commercial frameworks and architectures. Such benefits are expected to greatly enhance interoperability of communication systems and reduce development and deployment costs.

SCA has been defined not only be used in government and military applications, but also to be adopted by the commercial sector as a viable candidate for a software-defined radio (SDR) software architecture. Consequently, SCA is currently being reviewed by the Software Defined Radio Forum for its applicability to commercial use incorporating the SDR platform. SDR is a highly adaptable and software-programmable radio system which provides functionality independent of underlying hardware. In particular, radio functions for SDR are performed by software applications operating on general purpose computer resources. Accordingly, the radio functions of SDR can be inexpensively and quickly changed through a software upgrade, without requiring a change in hardware. Further, SDR's have a component-based architecture, which supports adaptability by making possible the replacement of software modules through the implementation of well-defined interfaces and clearly demarcated functional boundaries. To provide for portability of SDR application software, SCA encourages the use of commercial and industry standards, protocols, and products. Further, SCA abstracts essential and non-essential applications from the hardware platform and commercial software components, and uses Common Object Request Broker Architecture (CORBA) middleware to provide for distributed processing for software portability, scalability, and re-use.

As described, both GSM and SCA provide radio resources, but each go about it in a unique way and they address different environments. GSM is hardware specific and has been defined with only one waveform and one specific radio architecture. SCA, in contrast, is defined to address multiple waveforms, although GSM is not one of the waveforms which is anticipated to be implemented with SCA. Further, SCA is radio generic, which permits a variety of hardware implementations. Importantly, instead of focusing on system hardware, SCA focuses on system operation.

Another distinction is that GSM also does not provide for the portability of application software, the reason being that implementation of a single waveform does not necessarily need to concern itself with movement between different platforms. Accordingly, GSM supports only the architecture defined for GSM hardware. Moreover, GSM does not encourage the use of commercial products or technologies, relying on the individual GSM BSS suppliers to innovate. In contrast, SCA does provide portability of application software. In particular, SCA specifies an SDR framework, which is independent of underlying hardware and is thus adaptable to a wide range of systems. Furthermore, where SCA requires the use of CORBA to provide for distributed processing for software portability, scalability, and re-use, GSM mandates older standards, like LAPD, for communications. Lastly, both GSM and SCA each have their own, distinctly different object models, although both have their parentage defined in the ITU X-and M-series of standards to address the need to manage the systems represented by these models. The object models define inheritance, containment, and entity relationships. Intrinsic to each object is the identification of the attributes and operations requisite for each object.

Notwithstanding their differences, because GSM is currently prevalent throughout much of the world, and the use of SCA is expected to gain widespread recognition, a solution is needed to enable a BSS to interface with, and be administered by, both SCA and GSM management systems.

### SUMMARY OF THE INVENTION

The present invention relates to a network element of a communication system for supporting a plurality of software applications that are based on different object models. In one arrangement, the network element can be a base station system of a cellular phone network. A unified object model (UOM) is defined for the network element wherein the UOM has all of the attribute information of each of the different object models, exclusive of any redundant attribute information. For example, attributes of a GSM object model and an SCA object model can be combined in the UOM. A plurality of managed objects are stored in a management information base (MIB) of the network element, each of the managed objects conforming to the UOM. The MIB can be included in a network element memory storage.

A plurality of application programming interfaces (API's) are provided for communication between the plurality of managed objects in the MIB and the plurality of software applications for performing data accessing and mutation to support interoperability. The plurality of API's can include all methods associated with a respective object model. Further, a common middleware software interface layer, for example CORBA, can be used for communicating between the plurality of software applications and the MIB. At least one simple network management protocol (SNMP) agent can be provided to serve as an interface between the UOM and an SNMP manager.

### BRIEF DESCRIPTION OF THE DRAWINGS

FIG. 1 shows a simplified block diagram of a network element incorporating a unified object model in accordance with the present invention. FIG. 2A shows a graphical representation of the unified object model union of GSM and SCA methods in accordance with the present invention.

FIG. 2B shows a graphical representation of the unified object model union of GSM and SCA attributes in accordance with the present invention.

FIG. 2C shows an alternate graphical representation of the unified object model union of GSM and SCA attributes in accordance with the present invention.

FIG. 3 shows a flow chart for categorizing managed objects in accordance with the present invention.

### DETAILED DESCRIPTION OF THE PREFERRED EMBODIMENTS

The present invention relates to a unified object model, which is a rational, summative definition of multiple object model specifications. The unified object model can support administration of a network element by a plurality of management applications communicating via different network protocols. For example, the unified object model can support administration by Global System for Mobile Communication (GSM) management applications, Software Communications Architecture (SCA) management applications, simple network management protocol (SNMP) management applications, or any combination of these. In particular, the unified object model can include objects which are compatible with the GSM, SCA and SNMP network protocols. Further, the unified object model can be expanded to support administration by other applications as well, as such need arises.

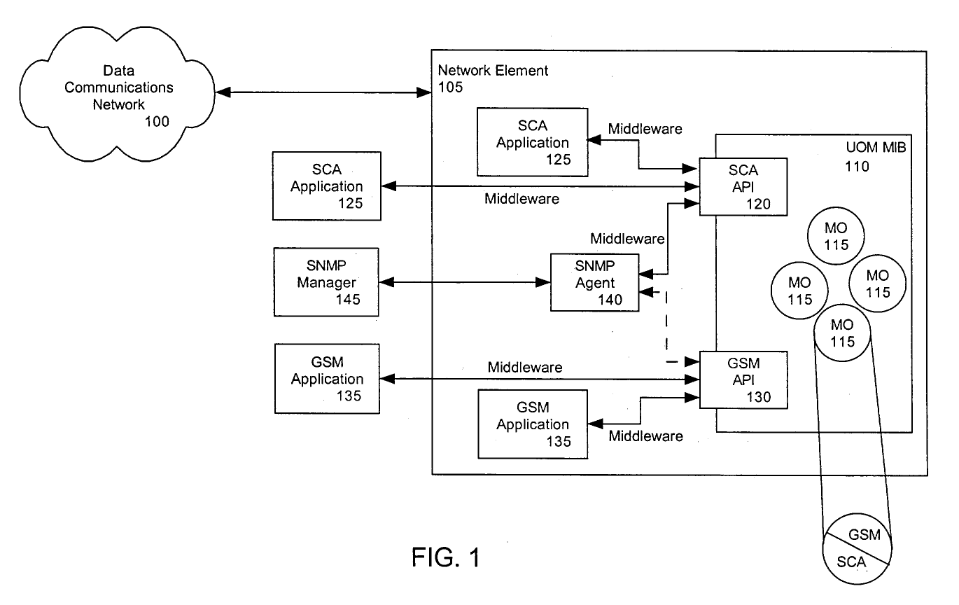

Referring to FIG. 1, a simplified block diagram 100 of a data communications network including a network element 105 is shown. The term data communications network is herein interpreted broadly and encompasses any network of devices wherein data is communicated. A data communications network can include, but is not limited to, computer networks, land based telephone networks, cellular telephone networks, mobile communications networks, video networks, satellite networks, etc. Further, network element 105 can be any element in a data communications network 100 that provides a network resource. For example, a network element 105 can be a wireless base station, a repeater, a management console, or any other item that can be included in a data communications network.

The network element 105 can include a unified object model (UOM) management information base (MIB) 110, which is a repository to store UOM managed object data definitions (managed objects) 115 on the network element 105. For example, managed objects 115 representing hardware and software resources can be stored in the MIB 110. The MIB 110 can be contained in a memory storage, for example a magnetic storage medium, such as a hard disk drive (HDD), an optical storage medium, such as a digital video disk (DVD), an electronic storage medium, such as random access memory (RAM), a magneto/optical storage medium, or any combination of storage devices.

An SCA application program interface (API) 120 can be provided with the MIB 110 to enable an SCA application 120 to access any managed objects 115 having resource attributes compatible with SCA. An attribute typically comprises two parts: a name and a value. In particular, attributes can represent any value, for example parameters, variables or data items, which are relevant to a particular protocol. Accordingly, an SCA management application, which is software that manages network resources, can access managed objects by interfacing with the API. For example, the API can include data accessors for reading object parameters and mutators for changing object parameters. A GSM API 130 also can be provided to enable a GSM application 135, for example a GSM management application, to access managed objects which are compatible with GSM. Importantly, some managed objects can be accessed by both the SCA API 120 and the GSM API 130.

Middleware, such as Common Object Request Broker Architecture (CORBA), can be used to facilitate interoperability between the applications 125, 135 and the API's 120, 130. Middleware is a class of software technologies designed to help manage the complexity and heterogeneity inherent in distributed systems. Middleware is defined as a layer of software above the operating system but below the application program that provides a common programming abstraction across a distributed system, as would be known to those skilled in the art of network architecture. For example, the SCA application 125 and/or GSM application 135 can be external to the network element 105 and connected to the network element 105 via a communications network, for example a local area network (LAN), a wide area network (WAN), the Internet, a public switched telephone network (PSTN), a public switched packet network (PSPN), or any other network that can carry data communications. Nonetheless, middleware also can be used for communications between applications 125, 135 within the network element 105.

An SNMP agent 140 also can be provided to act as an interface between the MIB 110 and an SNMP manager 145. Notably, the SNMP agent 140 can communicate with managed objects 115 via SCA API 120 and/or via GSM API 130. For example, the SNMP agent 140 can be programmed to communicate with the UOM MIB 110 using the SCA protocol or the GSM protocol. Again, middleware can be provided to facilitate interoperability between the SNMP agent 140 and the API's and the SNMP manager 145 can be external or internal to the network element 105. Further, the SNMP manager 145 and SNMP agent 140 can communicate with each other using SNMP, as is well known to the skilled artisan.

Significantly, the implementation of the UOM into the network element of FIG. 1 enables access to network element resources using any one of a variety of protocols. Thus, a user can access the UOM through a single uniform interface. More importantly, a user or an application need not be concerned with where, or in what format, an object model is persisted in order to read and change parameters associated with the object model. The user or application need only operate using one of the recognized protocols, for example, SCA, GSM, SNMP, or any other network application level protocol implemented into the network element. Any other underlying network protocols are transparent to the user or application. Moreover, the underlying computer language that holds the run-time instantiation of the object model is isolated from the user or application via the API's 120, 130 and middleware. Advantageously, a user or application programmer can choose one protocol from a selection of protocols which can be used to interface with the network element. Hence, the user or programmer can use a protocol with which he or she is most familiar.

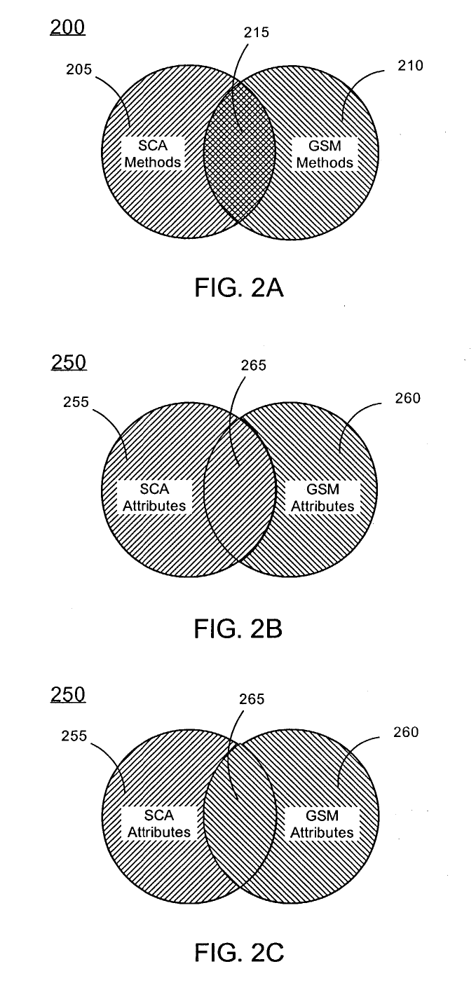

Referring to FIG. 2A, a graphical representation of the union of GSM object model methods (GOM_{M}) 205 and SCA object model methods (SOM_{M}) 210 to derive UOM methods (UOM_{M}) 200 is presented. The graphical representation is equivalent to the equation UOM_{M}=GOM_{M}∪SOM_{M}. Notably, the UOM represents a superset of all methods included in the GOM and SCA object models, as shown by the intersection 215 of the GOM and SOM methods. Accordingly, each of the GSM and SCA API's can include all of the methods associated with their respective protocols, which will insure complete functionality of a network element with each of the protocols. For example, each API can include all of the accessors and mutators defined by its respective protocol.

Referring to FIG. 2B, a graphical representation of the union of GSM object model attributes (GOM_{A}) 255 and SCA object model attributes (SOM_{A}) 260 to derive UOM attributes (UOM_{A}) 250 is presented. The graphical representation is equivalent to the equation UOM_{A}=SOM_{A}∪(GOM_{A}-SOM_{A}). An alternate representation of the UOM attributes is shown in FIG. 2C, which represents the equation UOM_{A}=GOM_{A}∪(SOM_{A}-GOM_{A}), which is equivalent to the previous equation presented for UOM attributes.

A managed object typically contains one or more attributes. Importantly, all attributes included in GSM and SCA are included in the UOM. However, because attributes are not always protocol specific, duplicate attributes can be removed in the overlap area 265 of the GOM and SOM attributes. For example, both the GSM object model and the SCA object model can include functionally identical attributes, such as an identification, a name, an operation state, an alarm state, or any other parameter. Since it is preferred that there are no duplicate attributes in the unified object model, redundant attributes can be eliminated from the unified object model (i.e. only one entry for each duplicate in GOM_{A}∪SOM_{A} is retained). For example, within the managed object model, a managed object can be defined which has only one occurrence of an attribute common to multiple protocols. Importantly, the managed object having the common attribute can be accessed by each of the protocols via respective API's associated with the protocols. Significantly, eliminating attribute redundancy eliminates a possibility of inconsistency between protocols, which violates correctness. Further, elimination of attribute redundancy increases memory resource efficiency and improves system maintainability.

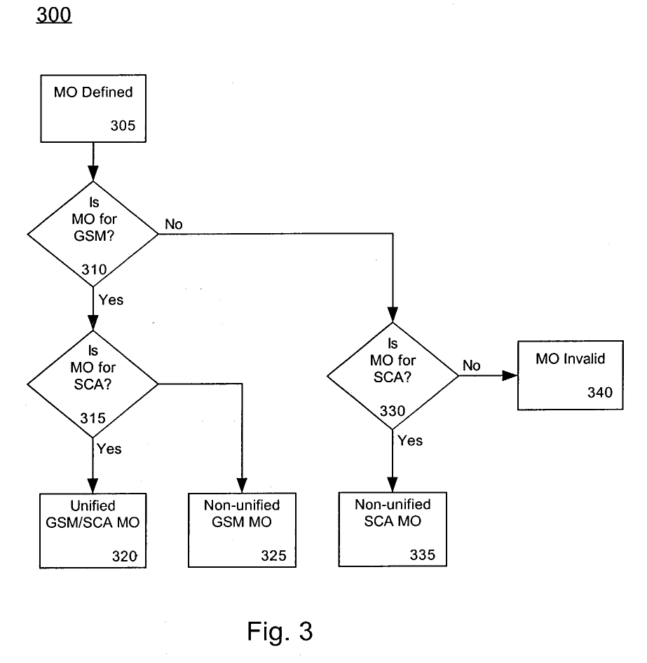

Referring to FIG. 3, a flow chart is presented for categorizing managed objects for a network element in accordance with the present invention. At step 305, a managed object can be defined. Referring to decision block 310, the managed object can be evaluated to determine if it is compatible with the GSM protocol. Referring to decision box 315, if the managed object is compatible with the GSM protocol and is also compatible with the SCA protocol, the managed object can be a unified GSM/SCA managed object within the UOM, as shown in step 320. Accordingly, both the SCA API and the GSM API can communicate with the managed object. If, however, the managed object is compatible with GSM but not SCA, the managed object can be a non-unified managed object, as shown in step 325, that only communicates with the GSM API. Referring to decision boxes 310 and 330 and step 335, if a managed object is only compatible with SCA, then the managed object can be a non-unified managed object that only communicates with the SCA API. If the managed object is not compatible with GSM or SCA, then the managed object can be identified as being invalid, as shown in step 340.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

1. In a communication system, a method for supporting on a network element a plurality of software applications that are based on different object models, comprising the steps of:
defining a unified object model (UOM) for said network element that has all of the attribute information of each of said different object models, exclusive of any redundant attribute information;
storing a plurality of managed objects in a management information base (MIB) of said network element, each of said managed objects conforming to said UOM;
communicating between said plurality of managed objects in said MIB and the plurality of software applications through a plurality of application programming interfaces (API) for performing data accessing and mutation to support interoperability.

2. The method according to claim 1 wherein each of said plurality of API's include all methods associated with a respective object model.

3. The method according to claim 1 wherein said communicating step further comprises communicating between said plurality of software applications and said MIB using a common middleware software interface layer.

4. The method according to claim 3 further comprising the step of selecting CORBA as said middleware layer.

5. The method according to claim 1 wherein said storing step further comprises storing a plurality of managed objects for a base station system of a cellular phone network.

6. The method according to claim 5 wherein said defining step is further comprised of combining the attributes of a GSM object model and an SCA object model.

7. The method of claim 1, further comprising the steps:
specifying at least one simple network management protocol (SNMP) agent to serve as an interface between said UOM and an SNMP manager.

8. A network element of a communication system for supporting a plurality of software applications that are based on different object models, comprising:
a memory storage comprising a management information base (MIB) of said network element, said MIB containing a plurality of managed objects, each conforming to a unified object model (UOM) for said network element that has all of the attribute information of each of said different object models, exclusive of any redundant attribute information;
a middleware software communications layer facilitating communicating between said plurality of managed objects in said MIB and the plurality of software applications; and
a plurality of application programming interfaces (API) providing an interface between said middleware software communication layer and said MIB for performing data accessing and mutation to support interoperability of said plurality of managed objects with said plurality of software applications.

9. The network element according to claim 8 wherein each of said plurality of API's include all methods associated with a respective object model.

10. The network element according to claim 8 wherein said middleware layer is CORBA.

11. The network element according to claim 8 wherein said plurality of managed objects are for a base station system of a cellular phone network.

12. The network element according to claim 11 wherein said UOM is a combination of the attributes of a GSM object model and an SCA object model.

13. The network element according to claim 8 further comprising at least one simple network management protocol (SNMP) agent to serve as an interface between said UOM and an SNMP manager.
